(19) United States
(12) Patent Application Publication
(10) Pub. No.: US 2007/0124941 A1
(43) Pub. Date: Jun. 7, 2007

(54) High branch tree saw

(76) Inventors: Jahangir S. Rastegar, Stony Brook, NY (US); Thomas Spinelli, East Northport, NY (US)

Correspondence Address: Thomas Spinelli, 2 Sipala Court, East Northport, NY, 11731, US

(21) Appl. No.: 11/374,703

(22) Filed: Mar. 14, 2006

Related U.S. Application Data
(60) Provisional application No. 60/668,349, filed on Apr. 5, 2005.

(51) Int. Cl. B26B 13/00

(52) U.S. Cl. 30/249

(57) ABSTRACT

A saw for cutting an overhead object is provided. The saw including: an elongated pole having a first end held by a user and a second end; a holding mechanism disposed at the second end of the elongated pole, the holding mechanism having an opening for holding the overhead object; and a cutting blade movably disposed on one of the elongated pole or holding mechanism so as to define a cutting stroke within the opening.

### CROSS-REFERENCE TO RELATED APPLICATIONS

This application claims the benefit of U.S. Provisional Application Ser. No. 60/668,349, filed Apr. 5, 2005, the entire contents of which is incorporated herein by its reference.

### BACKGROUND OF THE INVENTION

1. Field of the Invention

The present invention relates generally to saws for cutting overhead objects and, more particularly, to a tree saw for cutting high branches.

2. Prior Art

FIG. 1 shows a typical garden saw 100 used to cut branches located at heights well above normal reach. The saw usually consists of a blade 101 having teeth (not shown) and a long extension pole 102. The saw only cuts the branch 104 on the cutting stroke, the direction of which is indicated by the arrow 103. In order for the user to make an effective cutting stroke, the saw must be moved in the direction of the arrow 103, while at the same time the saw must be forced against the branch 104. In FIG. 1, the force between the saw 101 and the branch 104, which is exerted by the user through the pole 102, is shown by the force 105. The force 105 (F_{N}) is nearly normal to the branch 104. If the distance from the point of contact between the blade 101 and the branch 104 to where the user is holding the pole 102 is L (indicated as 106 in FIG. 1), and if the contact force 105 is indicated as F_{N}, then the user must have provided a moment M (107) to the pole 102, where M is given as:
M=LF_{N} (1)

Therefore to cut the branch 104 by the saw 101, the user must also produce a sawing force F (108) and a couple moment M to generate the normal contact force 105 between the saw blade and the branch 104, as indicated in FIG. 1. The sawing force 108 is independent of the length of the extension pole 102 and depends on the level of the normal force 105 and the generated resistance due to the cutting action. The moment 107, however, is directly proportional to the length of the extension pole 102, i.e., the further the branch 104 is from the user, the longer is the pole 102 and the larger the moment that the user has to produce for a given normal force 105. To make an efficient cut, the user has to produce a considerable normal force 105, thereby has to also provide a considerable amount of moment 107 (normally by producing a couple by two hands holding the pole a certain distance apart). Furthermore, the saw only moves and cuts the branch 104 due to the work done by the sawing force 108 (F). The moment 107 on the other hand has to be provided by the user just to produce the required normal force 105, which does only a negligible amount of work (equal to the cutting movement of the saw into the branch as the cutting edge of the blade 101 moves forward). Thus, the energy spent by the user to produce the applied couple (moment 107) is not converted into usable mechanical work and is wasted. Considering the fact that such tree branch saws are intended to cut high branches, the amount of energy that the user has to spend to generate the moment 107 very quickly becomes overwhelming and the user tires fast, making it impractical to cut a branch which is more than 6-7 feet above the holding position in any reasonable amount of time. The process is even more tiring since the user has to assume an awkward posture by keeping to look up most of time so that the saw does not slip off the branch, while pulling at one point on the pole and pushing at another point, preferably far apart. The process is even more difficult when the branch is relatively flexible and moves with the applied normal force, a situation that is encountered not only when the branch has a small diameter but also when a part of the branch a certain distance from the truck of the tree is being cut.

Therefore, there is a need for hand-operated saws that could be used to cut high branches and other overhead objects of various sizes.

There is also a need for hand-operated saws that are ergonomic, thereby allowing the user to cut branches or other overhead objects without having to assume an awkward posture and to have to exert excessive forces that do not significantly contribute to the work done to cut the branch or other object by the saw.

There is also a need for hand-operated saws that could hold on to a branch or other overhead object to be cut, particularly smaller and more flexible branches, and allow the user to cut them without having to struggle to keep the saw blade at the cutting location and being able to maintain a considerable amount of force between the blade and the cutting surface.

### SUMMARY OF THE INVENTION

The saws disclosed and claimed herein not only overcome the aforementioned shortcoming of the existing saws used to cut tree branches, but also allow cutting of very high branches or other overhead objects of almost any size. The following are some of the advantages of the saws disclosed and claimed herein:

Can be used to cut branches and other overhead objects of various sizes.

Can cut branches and other overhead objects that are located significantly higher than those that could be cut with current saws.

The cutting process requires significantly less effort.

During the cutting, the user does not have to provide a stabilizing force and coordinate hand motion with the location of the saw on the branch or other overhead object being cut to prevent the saw from being moved past the branch or other object being cut. In which case, the user has to provide a very large balancing force (moment) to prevent the saw from falling.

Unlike existing saws, during the cutting process, the pole is not subject to buckling (compressive force as the user pushes the pole up before pulling it down). The saw poles disclosed herein are in tension during the entire sawing cycle. As a result, the pole needs only to be rigid enough in bending to allow the saw to be lifted to the desired height, and could be used to reach very high branches or other overhead objects to be cut.

Pulling a rope or cable produces the cutting action, which the user could hold where it is most comfortable. As a result, the cutting action is ergonomic.

During the cutting process, the weight of the saw pole and part of the moving parts, including the saw mechanism, is born by the branch or other overhead object to be cut and not by the user, unlike existing tree saws.

Unlike existing tree saws, the user may stop the cutting process at any time without having to remove the saw before stopping the cutting process and resting or leaving the area for a short time (and position it back on the branch or other overhead object to resume the cutting process).

The user has to spend significantly less energy to cut a branch or other overhead object using the saws disclosed and claimed herein than is necessary with existing tree saws.

Branches or other overhead objects to be cut that are flexible (bend under the applied normal force 105) or rigid (do not bend under the applied normal force 105) may both be readily cut.

With the saws disclosed and claimed herein, the user need only generate the equivalent of the cutting force 105 and not the couple moment 107 (the user need to apply a small force to the pole to keep it from moving during the cutting action). As a result, a significantly more efficient overhead saw is provided. In addition to the improved efficiency of such a device, its reach is not limited by the user's ability to provide the moment 107.

Accordingly, a saw for cutting an overhead object is provided. The saw comprising: an elongated pole having a first end held by a user and a second end; a holding mechanism disposed at the second end of the elongated pole, the holding mechanism having an opening for holding the overhead object; and a cutting blade movably disposed on one of the elongated pole or holding mechanism so as to define a cutting stroke within the opening.

The saw can further comprise a biasing member for biasing the cutting blade against the overhead object.

The holding mechanism can have a first member disposed at the second end of the elongated pole and a second member disposed at an end of the first member to define the opening. The holding mechanism can further have a curved transition portion disposed between the first and second members. The curved transition portion can be a flexible member. The holding mechanism can also have a curved portion disposed on an end of the second member for facilitating capturing of the overhead object into the opening.

The holding mechanism can have a curved member disposed at the second end of the elongated pole to define the opening. The holding mechanism further having a curved portion disposed on an end of the curved member for facilitating capturing of the overhead object into the opening.

The holding mechanism can comprise a first member attached to the second end of the elongated pole and a second member movably supported on the first member, at least a portion of the first and second members defining the opening.

The holding mechanism can comprise: a member rotatably supported on the elongated pole; and one or more elastic elements for biasing the member towards the elongated pole. The member can have one or more curved sections for holding overhead objects of differing sizes. The saw can also further comprise a mechanism for constraining the member to move in a parallel manner.

The saw can further comprise one or more stops for limiting the movement of the cutting blade.

The holding mechanism can comprise: a first member disposed at the second end of the elongated pole; and a second member removably disposed on the first member, the first and second members defining the opening and the second member being interchangeable with second members of differing size.

The saw can further comprise a linkage mechanism for movably disposing the cutting blade relative to the opening. The saw can further comprise one of a cable and rope attached to at least a portion of the linkage mechanism for actuating the blade through the cutting stroke. The linkage mechanism can be a first parallelogram linkage having one end rotatably disposed on the elongated pole and another end rotatably connected to a second parallelogram linkage rotatably connected to the cutting blade, the first and second parallelogram linkages confining the cutting blade to a linear motion. The saw can further comprise one or more biasing members acting on one or more links of the first and second parallelogram linkages for biasing the cutting blade into a predetermined position. The linkage mechanism can be a link member having a first end rotatably connected to the elongated pole and a second end rotatably connected to the cutting blade. The saw can further comprise one or more biasing members acting on one or more of the link member and the cutting blade for biasing the cutting blade into a predetermined position.

Also provided is a method of cutting an overhead object. The method comprising: holding the overhead object within an opening; and actuating a cutting blade through the opening to cut the overhead object.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates a schematic view of a conventional tree saw of the prior art.

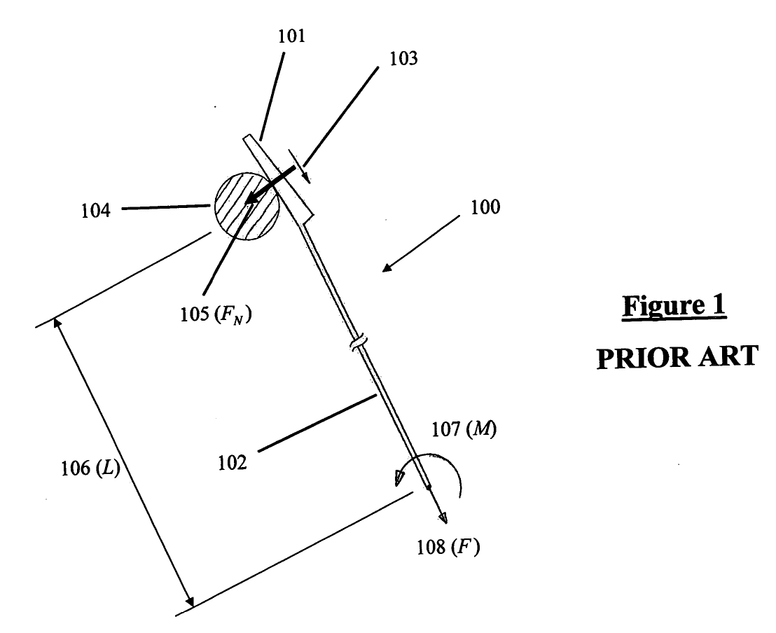

FIGS. 2a-2c illustrate variations of fixed holding mechanisms for holding a branch to be cut.

FIG. 2d illustrates a section view of any of the hook members of FIGS. 2a-2c.

FIGS. 3a and 3b illustrate variations of adjustable holding mechanisms for holding a branch to be cut.

FIG. 3c illustrates a variation of the adjustable holding mechanism of FIG. 3b.

FIG. 3d illustrates another variation of the adjustable holding mechanism of FIG. 3b.

FIG. 4 illustrates an embodiment of a tree saw.

FIGS. 5a-5c illustrate a sequence of a cutting stroke using the saw of FIG. 4.

FIG. 6 illustrates a variation of the saw of FIG. 4.

FIG. 7 illustrates a top portion of an embodiment of a tree saw.

FIG. 8 illustrates the saw of FIG. 7 retaining a branch.

FIG. 9 illustrates the saw of FIG. 8 cutting a branch.

FIGS. 10a and 10b illustrate variations of the saw of FIG. 7 having elastic elements for biasing the saw blade.

FIG. 11 illustrates a top portion of a saw.

FIG. 12 illustrates the saw of FIG. 11 retaining and cutting a branch.

FIGS. 13a and 13b illustrate another embodiment of a saw in which FIG. 13a illustrates capturing a branch and FIG. 13b illustrates retaining the branch once it is captured.

FIGS. 14 and 15 illustrate operation of the tree saws from a ground position by one or two users, respectively.

### DETAILED DESCRIPTION OF THE PREFERRED EMBODIMENT

Although the present invention is applicable to cutting overhead objects, it is particularly useful in the environment of cutting branches from a tree and particularly high branches from a tree. Therefore, without limiting the applicability of the present invention to cutting branches from a tree and particularly high branches from a tree, it will be described in such environment.

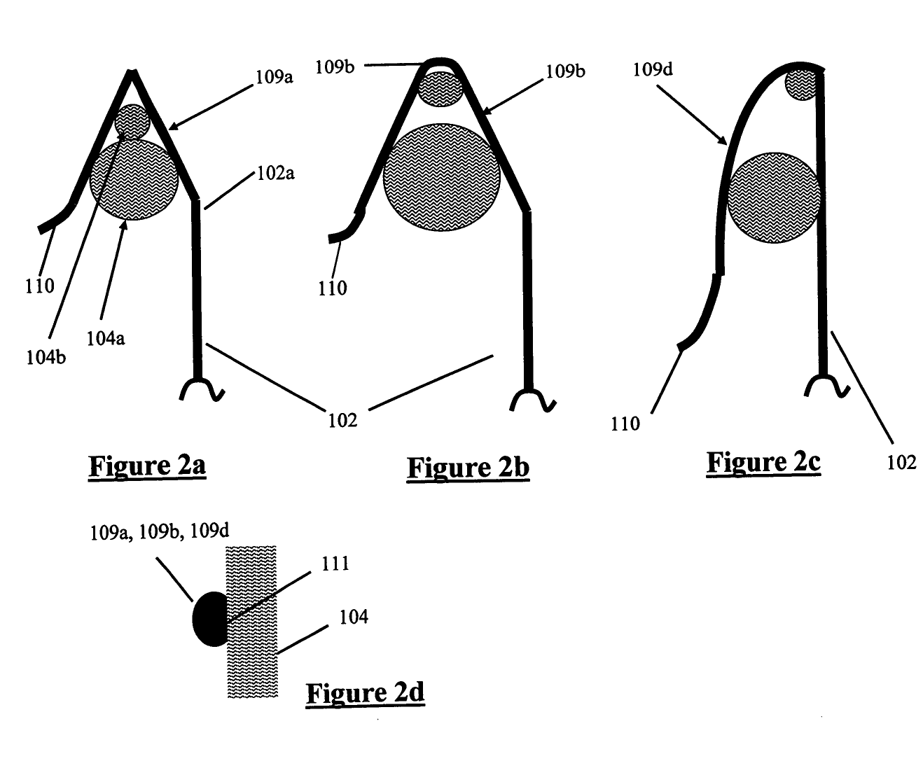

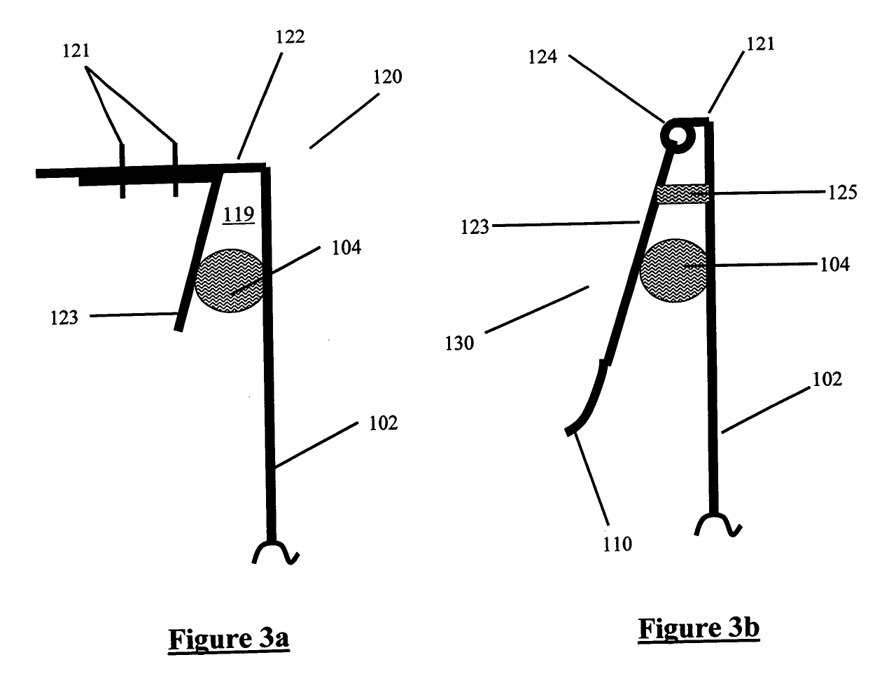

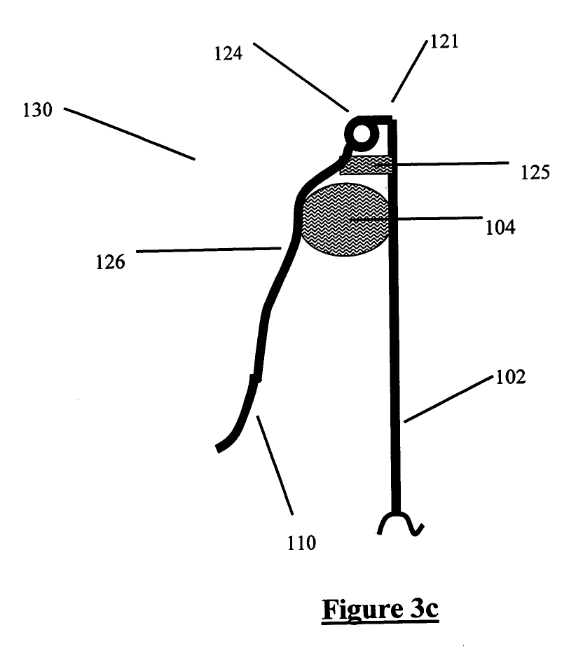

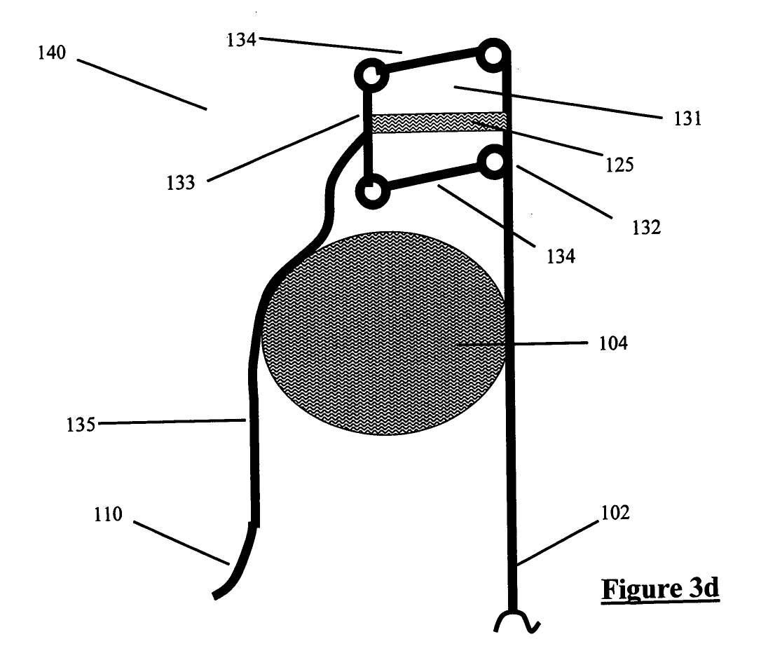

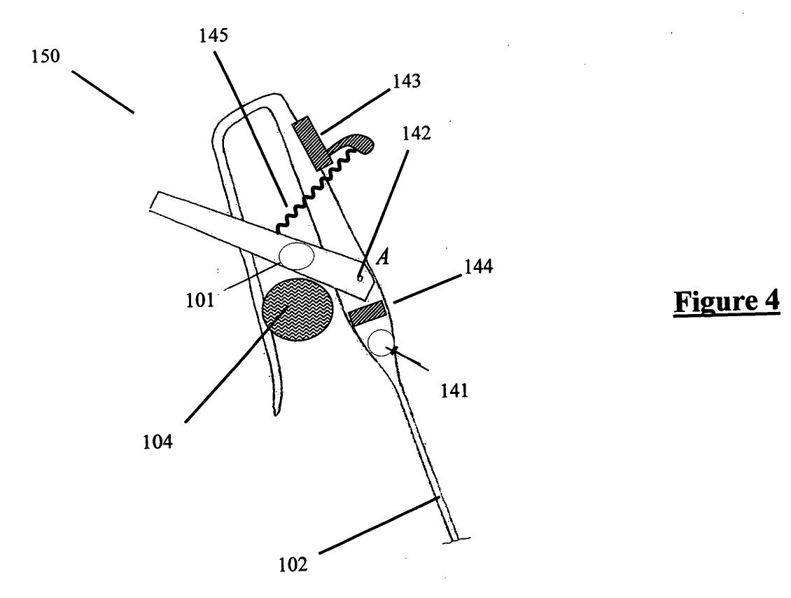

The tree saws disclosed herein are held in place relative to the branch by fixed or adjustable structures, a number of variations of which are shown in FIGS. 2a-2d and 3a-3d, and are hereinafter called “holding mechanisms.” The holding mechanisms provide a means of holding the tree saw onto the branch at the location where the saw blade is to cut the branch. The holding mechanism can handle branches of a wide range of size (diameter) by providing a fixed (FIGS. 2a-2d), manually adjustable (FIG. 3a), or spring-loaded adaptable (FIG. 3b) hook width. The holding mechanism may also be adjustable from the ground by the user by, e.g., pulling a cable (not shown). The holding mechanism supports the weight of the entire tree saw and would require minimal force by the user to keep it in properly oriented while the branch is being cut. In addition, since the holding mechanism provides a stable means to suspend the tree saw from the branch, the user may leave it in place while resting or attending to other tasks.

FIGS. 2a-2c a show a first embodiment of the holding mechanism, which is a relatively rigid hook member 109a, 109b and 109d and is attached to an end 102a of the pole 102. The hook member 109 can be an integral part of the top portion of the pole 102 or attached separately. The hook member 109 is shaped such that its open end accommodates the largest branch 104a to be cut and narrows down to also accommodate the smallest branch 104b to be cut. FIG. 2a shows an inverted V shaped hook member 109a, FIG. 2b shows an inverted V shaped hook member 109b with a curved transition 109c and FIG. 2c shows a curved hook member 109d. The tip of the hook shaped portion 109a, 109c and 109d can have a curved portion 110 to make it easier for the user to place it over a branch high up on the tree. As shown in FIG. 2d, the inside surfaces of the hook member 109a, 109c and 109d can have a flat portion 111 to increase the surface of contact between the hook member and the branch 104 and to also resist rotation of the hook member relative to the branch, thereby minimizing the application of lateral force and/or bending moment on the saw blade (described below) as it cuts through the branch as a result of unavoidable slight movements of the pole (tree saw) during the cutting process. The surfaces of the hook member 109a, 109b, 109d and/or pole 102 (see FIG. 2c) contacting the branch 104 can be treated or coated to increase holding and reduce slippage. For example, surface 111 can have a rubberized coated.

In another embodiment, the width of the hook holding mechanism can be adjustable to hold various size branches to be cut. FIG. 3a illustrates an adjustable width hook holding mechanism 120 having a relatively rigid member 122, which is rigidly attached or integral with the pole 102. An adjustable relatively rigid structural element 123 is then fastened to the member 122 at an appropriate position to provide a wide enough opening 119 to accommodate the branch to be cut. One or both elements 122 and 123 are provided with an adjustment means, such as holes or slots and corresponding fasteners 121 along their length to allow for the desired range of variations in the holding mechanism opening. Such adjustment means are well know in the art. The provided opening is then variable to accommodate a range of branch sizes.

Similarly, FIG. 3b illustrates an adjustable width hook holding mechanism for accommodating a variety of branch sizes. The adjustable width hook holding mechanism 130 has one or more links and is attached to the pole 102 with one or more rotary or sliding joints 124. For the sake of simplicity, an adjustable hook holding mechanism 130 with a single link 123, which is attached to the top 121 of the pole 102 with a rotary joint 124 is shown. In one embodiment, at least one elastic element 125, which can be an integral part of the structure of the hook and/or mechanism 130 or provided separately therefrom is provided to bias the single link 123 to close, i.e., to tend to bring the branch support link 123 closer to the pole side of the branch support surface. For example, the elastic element 125 can be one or more of a torsional spring at the joint 124, an extension spring connected between the link 123 and pole 102 or an elastic material stretched between the link 123 and pole 102. The branch support link 123 is preferably constructed with a curved portion 110 to facilitate placement of the link 123 over a branch 104. Once the link 123 is placed over the branch 104, the user pulls the pole down until the branch is firmly held by the holding mechanism 130. The elastic element(s) 125 are preferably preloaded to provide an initial resistance to the opening of the link 123 relative to the pole 102.

Even though in FIG. 3b an adjustable holding mechanism 130 consisting of only one straight link is used for the sake of simplicity, the mechanism 130 can be constructed with a curved link 126 as shown in FIG. 3c to better hold branches of various sizes.

Referring now to FIG. 3d, there is illustrated an adjustable width hook holding mechanism having multiple links. The adjustable holding mechanism 140 provides for holding surfaces that are close to being parallel. The mechanism 140 shown in FIG. 3d is a parallelogram mechanism with upper and lower equal and parallel links 134, and a portion of the pole 102 and link 133 constituting the second pair of equal and parallel links of the parallelogram. Link 133 would therefore stay parallel to the pole at all times, thereby forcing the holding member 135, which is fixed to the coupler link 133, to undergo parallel motion only. An elastic element 125 can be used to provide for the branch holding force.

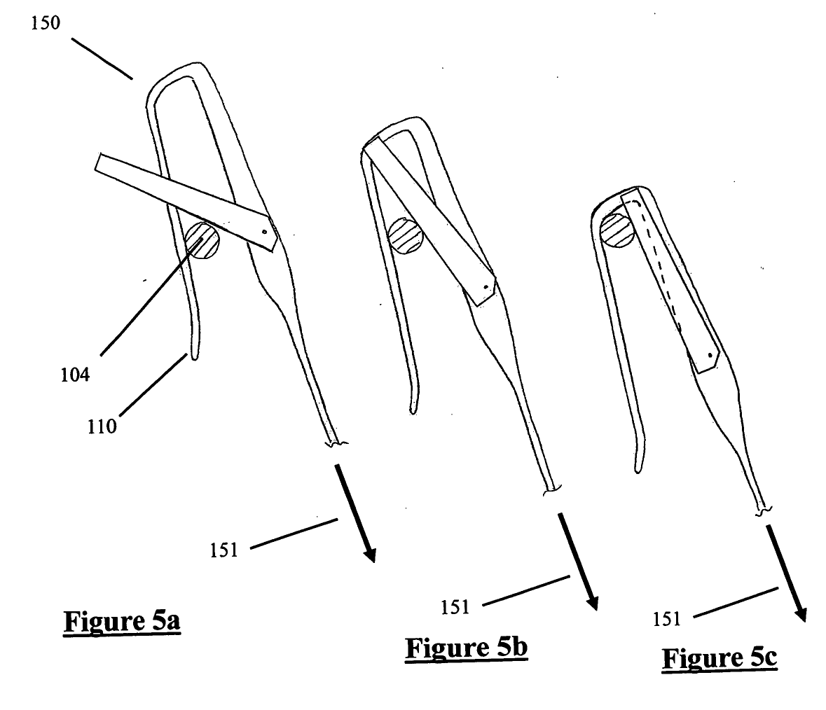

Referring now to FIG. 4, there is shown a saw 150 having a holding mechanism. Although shown with a fixed width hook holding mechanism of a particular shape, any hook holding mechanism can be used. In the embodiment of FIG. 4, the tree saw 150 consists of a saw blade 101 and a holding mechanism in the shape of a hook 141. The saw blade 101 is rotatably attached to the hook 141 with a pin joint 142 at point A. The rotation of the saw blade 101 is preferably limited between upper 143 and lower 144 rotation limiting stops as shown in FIG. 4. At least one spring element 145 is provided between the blade 101 and the hook 141 to bias the blade 101 towards a cutting surface of the branch 104 to provide a near normal pressure between the cutting edge of the blade and the branch 104.

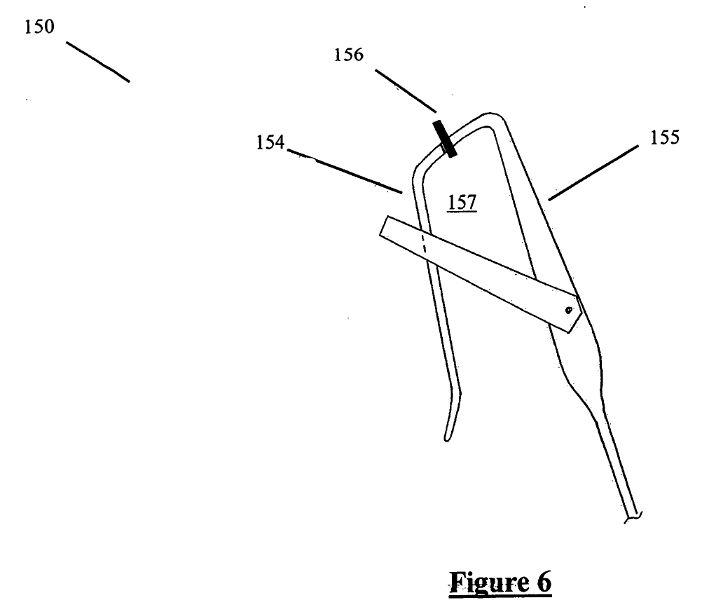

Referring now to FIGS. 5a-5c, there are shown three sequential images of the saw 150 performing a cutting stroke on a tree branch (with the stops and spring element not shown for simplicity). As shown in FIG. 5a, the saw 150 is raised above the branch 105 to clear hook portion 110 and then lowered in direction 151 so that the branch 104 makes contact with the cutting edge of the blade 101 and an inner surface of the hook 141. FIG. 5b shows the saw 150 being pulled downward relative to the tree branch in the direction 151. The blade 101 begins to swing clockwise relative to the hook 141. The preloading provided by the spring element 145 (not shown in FIGS. 5a-5c) biases the blade against the branch 104. FIG. 5c shows downward movement of the saw 150 to the end of the cutting stroke. In order to perform a second or subsequent cutting stroke, the entire device is raised back upward opposite to the direction 151. The saw of FIGS. 4 and 5a-5c does not require a rope or cable for actuation of the blade. The biasing of the blade against the branch and the up and down movement of the saw (in and opposite to the direction 151) provides the cutting stroke.

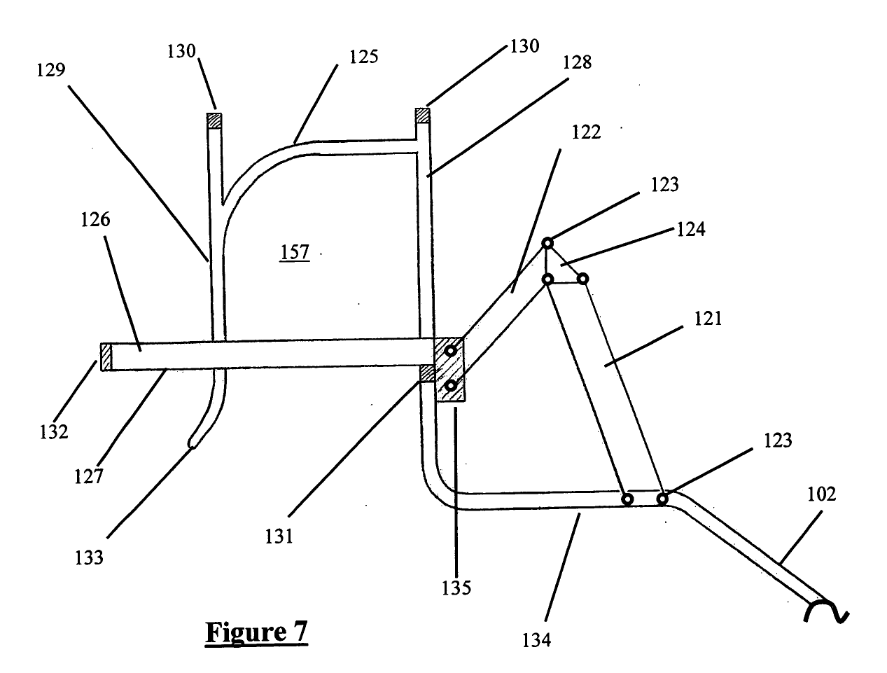

Referring now to FIG. 6, the holding mechanism 141 of the saw of FIG. 4 can be made adjustable to accommodate branches of various sizes. This can be done, for example, by making the hook with a front piece 154, which is attached to a back piece 155 by at lest one fastener 156 as shown in FIG. 6. The front and back pieces are preferably provided with a number of coinciding holes to allow for a range of adjustments for a wide range of branch sizes to be cut. Thus, the front piece 154 can be exchanged with another front piece to provide for a larger or smaller opening 157 to accommodate various size branches or ranges of branch sizes.

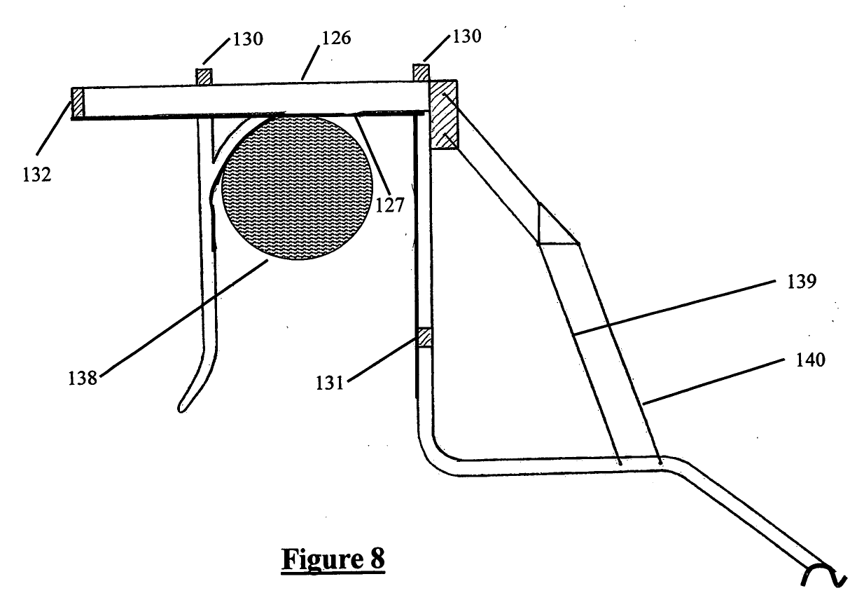

Another embodiment of a saw is shown in FIG. 7. In FIG. 7, the head (top portion) of the tree saw and only a small part of the pole 102 is shown. The head of the saw consists of a hook with side piece 128, top piece 125 and end 129, which can be provided with a curved piece 133 for ease of engaging a branch. A saw blade 126 with a sawing edge 127 is attached to the hook or the top of the pole 102 or a portion in-between 134 via two parallelogram linkages 121 and 122 (shown as simple lines for simplicity). The parallelogram linkage 121 is attached to the portion 134 by a pair of pin joints 123 on one side and to the relatively rigid element 124 by a second pair of pin joints 123 on the (top) side. The parallelogram linkage 122 is attached to the element 124 by a pair of pinjoints 123 on one side and to the element 135 by a second pair of pin joints 123 on the other side. The saw is fixed to the element 135, which also acts as a stop against the side piece 128 of the hook to prevent the saw from moving past the hook area when moving to the left. Another stop 132 is fixed to the opposite end of the saw 126 to prevent it from moving past the side piece 129 of the hook while moving to the right. As known in the art, portions of the stops engage corresponding portions of the hook sides to prevent further motion of the blade. As a result, the saw blade 126 is constrained to back and forth motion with the cutting edge 127 staying within the hook opening 157 at all times. The function of the parallelogram linkages 121 and 122 is to allow the saw blade 126 to traverse the length of the hook (up and down in FIG. 7) and back and forth relative to the hook in parallel motions, i.e., without any rotation relative to the hook. A stop 131 is provided to limit downward movement of the saw. Stops 130 prevent the saw from moving up past the hook area. Elastic elements (e.g., springs, elastic materials) (not shown) bias the saw down against the stop 131 and to the left, forcing the stop 135 against the side 128 of the hook.

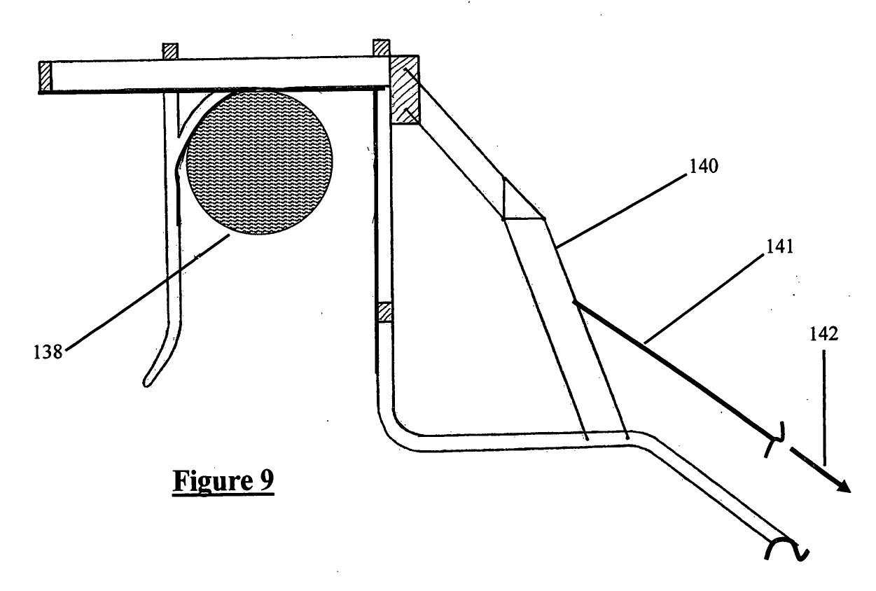

FIG. 8 shows the tree saw of FIG. 7 hooked onto a tree branch 138. The blade 126 has been forced upward by the branch 138 against stops 130 and the cutting edge 127 is in contact with the branch 138. The blade 126 remains parallel and is forced downward against the branch and to the left by way of the elastic elements (not shown). The two stops 130 at the top of the hook may or may not be required to stop the blade depending on the size of the branch 138. The stops 130 are, however, required to prevent the blade from coming away or out of the cutting area during transport or misuse.

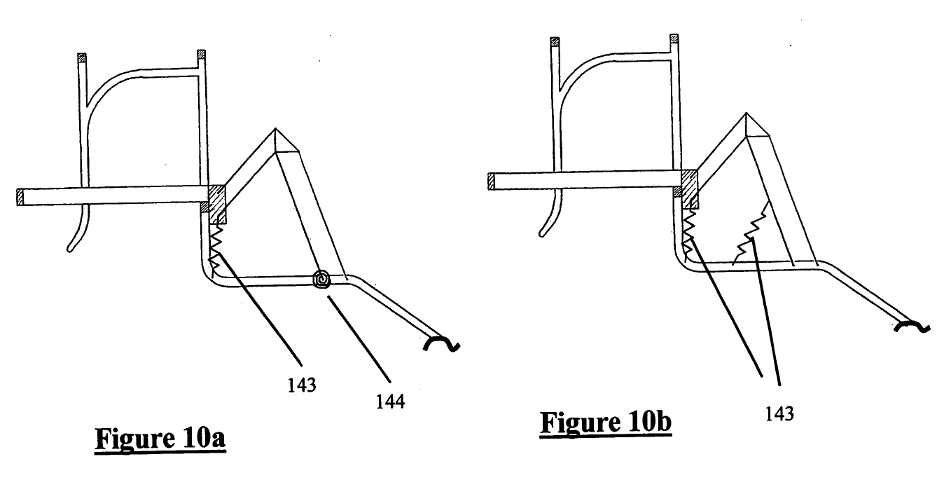

In order to perform a cut, the user must draw the blade to the right from the ground. This can be achieved, e.g., if one of the two lower links 139 and 140 of the parallel mechanism 121 is rotated clockwise. A user on the ground could accomplish this by pulling on a rope element 141 connected to one of the links, preferably the link 140, as shown in FIG. 9, and pulling it in the direction of the arrow 142. The blade will move to the extreme right before stopping as a result of the stop 132 on the left edge of the blade. This completes a single cutting stroke. Once the cut is complete, the user can release the rope, and the elastic elements would then force the blade to its aforementioned extreme right hand position.

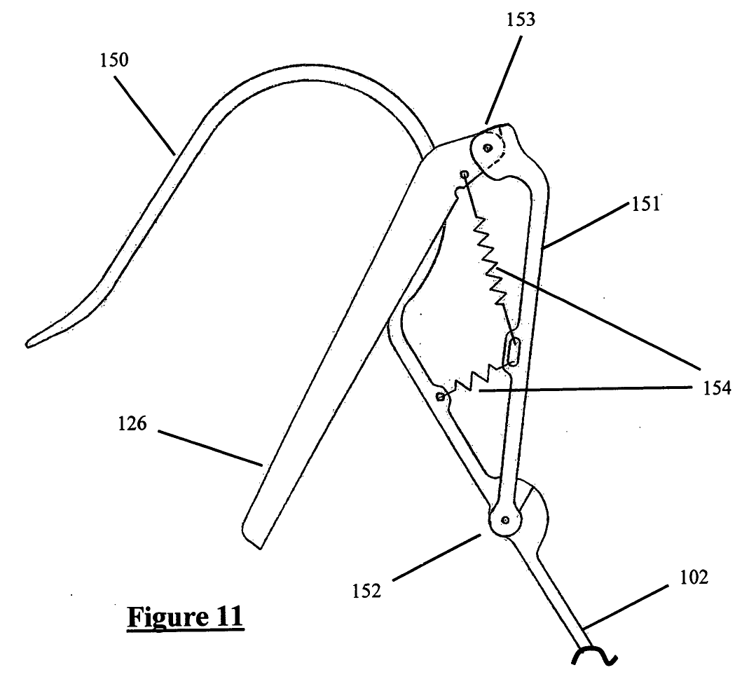

In FIG. 10a the saw of FIG. 7 is shown with at least one extension spring 143 and/or at least one torsional spring 144. FIG. 10b illustrates the saw of FIG. 7 with two extension springs 143. The elastic element(s) (143, 144) are employed to ensure that the blade 126 will be biased to return to the indicated position, i.e., its left most position, after every cut, and that a desired amount of pressure is maintained between the cutting edge 127 of the saw and the branch 138. It is, however, appreciated and any other type of spring and/or elastic element, and numerous other attachment configurations may be used to accomplish the same task. Alternatively, the links of one or both parallelogram linkages may be constructed with living joints, preferably only on the pole side 134, and built with enough flexibility (with and without other elastic elements, possibly also as incorporated into the structure of the hook or the second parallelogram mechanism) to reduce or eliminate the need for any other spring element such as those of springs 143 and 144.

In a variation of the embodiment of FIG. 7, the hook is made with at least two pieces that are connected together to make the hook adjustable to fit different branch sizes (for example, using adjustment methods shown in FIG. 3a or 6).

In another variation of the embodiment of FIG. 7, other type of linkage mechanisms, e.g., a four-bar linkage mechanism may be used in place of either one of the two parallelogram mechanisms. As a result, the saw blade 126 would rotate as well as translate as it is used to saw a branch. This may be done to get a better mechanical advantage as the user pulls the rope 141. In general, any type of mechanism, linkage type, pulley and cable type, gear type, cam type or any of their combination may be used as long as the user pulling on a rope (cable, link, etc.) can produce the back and forth cutting motion of the saw (with or without a simultaneous rotation). In addition, the stops that can be used to constrain the motion of the blade to the area of the hook, i.e., to the region in which a branch is being held captive, may be built into such mechanisms and frame (of the hook or the pole itself).

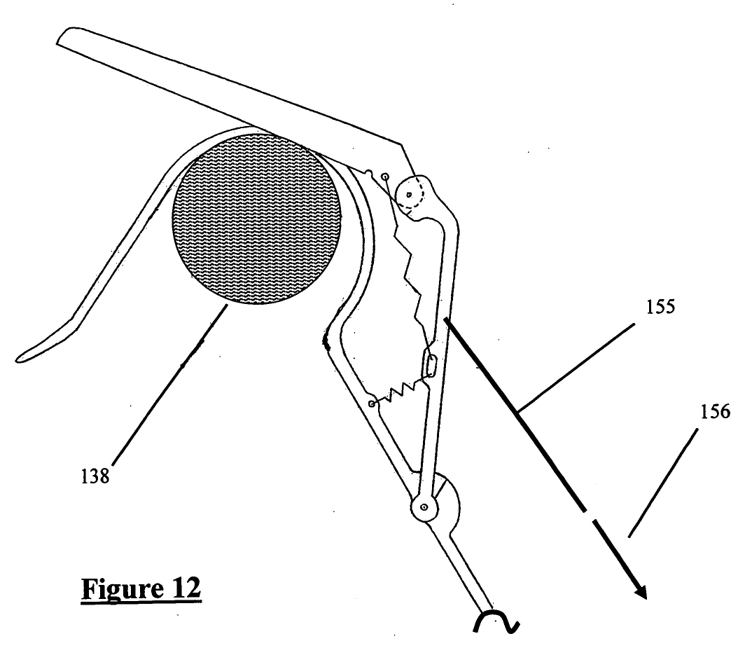

In another embodiment shown in FIG. 11, a simple link 151 is used instead of the double parallelogram linkages of the embodiment shown in FIG. 7. The link 151 is attached to the pole 102 by a pin joint 152 and to the saw blade 126 by another pin joint 153. In FIG. 11, the hook is indicated as 150. At least one elastic element 154 is used to bias the link 151 towards the hook 150 (and pole 102) and bias the saw blade 126 downward (in the position shown in FIG. 11) to provide an appropriate contact force between the saw 126 and the branch to be cut (to be positioned inside the hook as shown in the previous embodiments). Motion (rotation) limiting stops (not shown) are preferably built into the joints 152 and 153 to ensure that the link 151 and the saw blade 126 do not rotate excessively in the counterclockwise direction. The position of the link 151 and blade 126 shown in FIG. 11 can be the maximum counterclockwise rotation that is allowed.

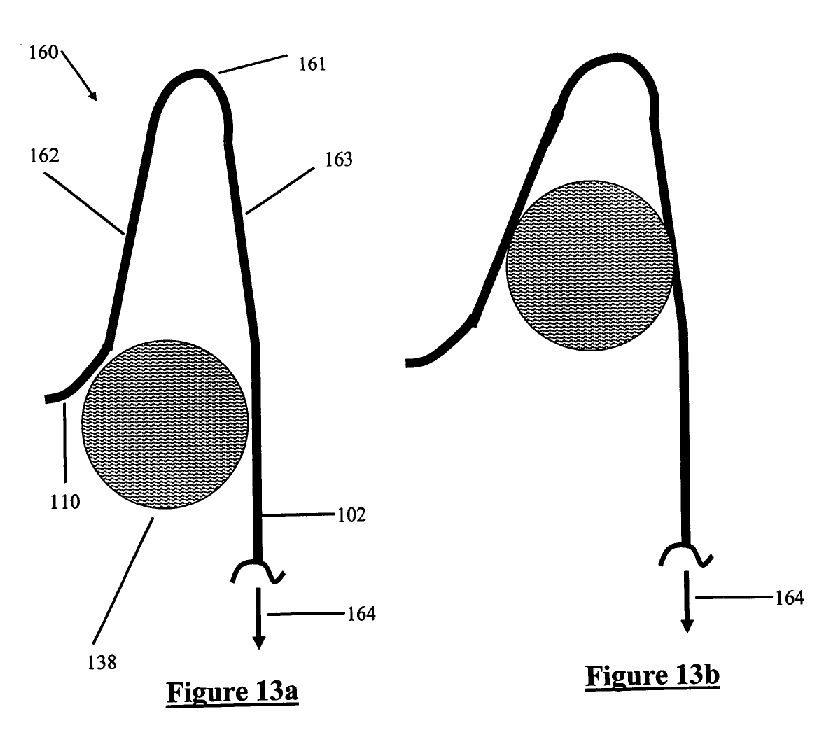

The aforementioned limit positioning of the link 151 and the saw blade 126 is required so that as the hook is placed over a branch, the blade is positioned on the top of the branch with the elastic element(s) 154 providing the desired level of pressure between the saw blade 126 and the branch 138, as shown in FIG. 12. In the position shown in FIG. 12, the elastic element(s) 154 are seen to be firmly forcing the saw blade 126 against the branch 138. In the configuration shown in FIG. 12, the elastic element(s) 154 are also forcing the link 151 to its most counterclockwise position as provided by the limit stop at joint 152. This allows the saw to be pulled back (to the right) to perform its cutting action by the user pulling the link 151 down by a rope 155 in the direction of the arrow 156.

In a variation of the embodiment of FIG. 11, the hook is made with at least two pieces that are connected together to make the hook adjustable to fit different branch sizes (for example, using adjustment methods shown in FIG. 3a or 6).

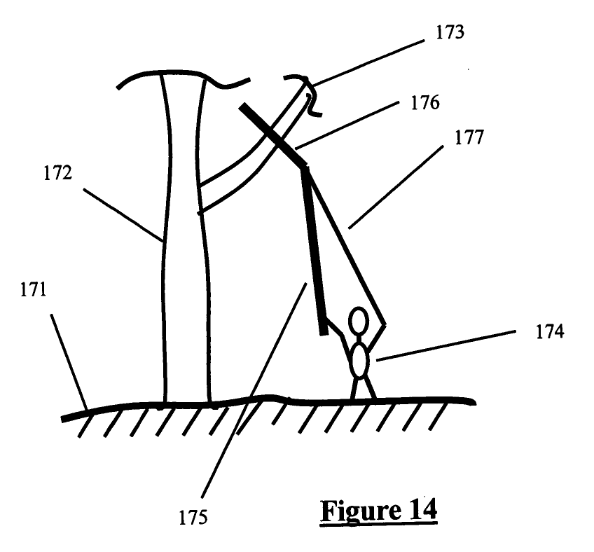

In a variation of the aforementioned adjustable width hook embodiments, the hook structure can have at least a relatively elastic portion or component to allow it to open and adjust to the larger branch sizes. An example of such an embodiment is shown in FIGS. 13a and 13b. In FIGS. 13a and 13b, the hook 160 is shown to consist of a relatively elastic segment 161, which attaches the relatively rigid front portion 162 and a relatively rigid back portion 163. The tip of the front portion can be a curved segment 110 to facilitate capturing of the branch 138. The user first captures the branch 138 by positioning the hook above it as shown in FIG. 13a, using the pole 102. The hook 160 is then pulled down in the direction of the arrow 164 to force the hook 161 tightly around the branch 138 as shown in FIG. 13b. The elastic element 161 is preferably stiff enough to provide enough resistance to the opening of the hook to allow a relatively firm gripping of the branch. The elastic element 161 can be any material known in the art for such purpose, such as spring steel. Any of the cutting mechanisms discussed above can be used together with the adjustable width hook mechanism of FIGS. 13a and 13b.

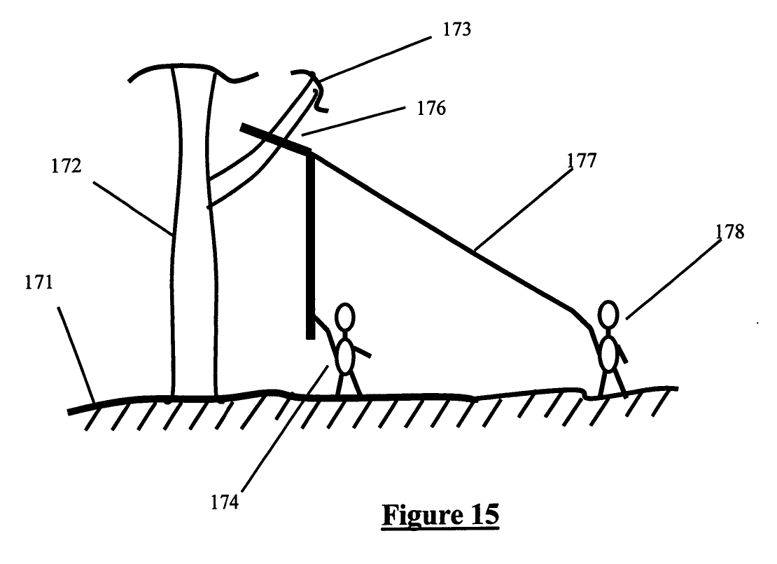

In the above embodiments, the user is considered to be on the ground and cutting branches that are more or less horizontal relative to the ground. The tree saw hook is therefore positioned more or less in the vertical plane and the saw blade is also considered to be positioned and moving in such a more or less vertical plane. The aforementioned tree saws may, however be held at an angle, the amount of which is dependent on the height of the branch being cut (less angle is generally possible for higher branches). Alternatively, angle adjustment means may be provided that allow the plane of the hook (and the saw) to be tilted a certain amount, preferably not a large amount, such as less than 45 degrees in order to engage branches that are more vertical. The tilt angle is desired to be small in order not to hamper the transmission of force from the actuating rope (e.g., rope 155 in FIG. 12) to the blade mechanism in the direction of operating the saw. In FIG. 14, such a hook tilt angled configuration is shown being used by a user. The user 174 is standing on the ground 171 below the tree 172 with a branch 173 that is to be cut at the position where the tilted hook and saw assembly 176 is placed on the branch as previously described for the earlier embodiments of the present invention. The hook and saw assembly 176 is tilted relative to the pole 175 and locked in place (to the pole 175). The user 174 holds and pulls on the pole 175 to firmly hold the hook onto the branch 173 by one hand and pulls on the actuating rope 177 by the other hand to operate the saw to cut the branch as previously described for the other embodiments.

Alternatively, another person 178, as shown in FIG. 15, may pull the actuating rope 177. In FIG. 15, the hook and saw assembly 176 is shown to have a steeper angle relative to the pole 175, thereby making it possible for the tree saw to cut even a near vertical branch or the tree trunk itself. At such steep relative angles, the actuating rope 175 can be operated by a second person 178 in order to efficiently transfer motion and force to the saw mechanism. Alternatively, a spatial mechanism could be employed to transmit the nearly vertical motion of the actuating rope (by the user 174 or 178) to the back and forth cutting motion of the saw blade in the desired (angled) plane, which could even be horizontal. An endless number of spatial mechanism types may be selected for this purpose where general methods for their design are well known in the art of mechanism synthesis.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A saw for cutting an overhead object, the saw comprising:
an elongated pole having a first end held by a user and a second end;
a holding mechanism disposed at the second end of the elongated pole, the holding mechanism having an opening for holding the overhead object; and
a cutting blade movably disposed on one of the elongated pole or holding mechanism so as to define a cutting stroke within the opening.

2. The saw of claim 1, further comprising a biasing member for biasing the cutting blade against the overhead object.

3. The saw of claim 1, wherein the holding mechanism has a first member disposed at the second end of the elongated pole and a second member disposed at an end of the first member to define the opening.

4. The saw of claim 3, wherein the holding mechanism further having a curved transition portion disposed between the first and second members.

5. The saw of claim 4, wherein the curved transition portion is a flexible member.

6. The saw of claim 3, wherein the holding mechanism further having a curved portion disposed on an end of the second member for facilitating capturing of the overhead object into the opening.

7. The saw of claim 1, wherein the holding mechanism has a curved member disposed at the second end of the elongated pole to define the opening.

8. The saw of claim 7, wherein the holding mechanism further having a curved portion disposed on an end of the curved member for facilitating capturing of the overhead object into the opening.

9. The saw of claim 1, wherein the holding mechanism comprises a first member attached to the second end of the elongated pole and a second member movably supported on the first member, at least a portion of the first and second members defining the opening.

10. The saw of claim 1, wherein the holding mechanism comprises:
a member rotatably supported on the elongated pole; and
one or more elastic elements for biasing the member towards the elongated pole.

11. The saw of claim 10, wherein the member has one or more curved sections for holding overhead objects of differing sizes.

12. The saw of claim 10, further comprising a mechanism for constraining the member to move in a parallel manner.

13. The saw of claim 1, further comprising one or more stops for limiting the movement of the cutting blade.

14. The saw of claim 1, wherein the holding mechanism comprises:
a first member disposed at the second end of the elongated pole; and
a second member removably disposed on the first member, the first and second members defining the opening and the second member being interchangeable with second members of differing size.

15. The saw of claim 1, further comprising a linkage mechanism for movably disposing the cutting blade relative to the opening.

16. The saw of claim 15, further comprising one of a cable and rope attached to at least a portion of the linkage mechanism for actuating the blade through the cutting stroke.

17. The saw of claim 15, wherein the linkage mechanism is a first parallelogram linkage having one end rotatably disposed on the elongated pole and another end rotatably connected to a second parallelogram linkage rotatably connected to the cutting blade, the first and second parallelogram linkages confining the cutting blade to a linear motion.

18. The saw of claim 17, further comprising one or more biasing members acting on one or more links of the first and second parallelogram linkages for biasing the cutting blade into a predetermined position.

19. The saw of claim 15, wherein the linkage mechanism is a link member having a first end rotatably connected to the elongated pole and a second end rotatably connected to the cutting blade.

20. The saw of claim 19, further comprising one or more biasing members acting on one or more of the link member and the cutting blade for biasing the cutting blade into a predetermined position.

21. A method of cutting an overhead object, the method comprising:
holding the overhead object within an opening; and
actuating a cutting blade through the opening to cut the overhead object.
